(19) United States
(12) Patent Application Publication
(10) Pub. No.: US 2024/0149489 A1
(43) Pub. Date: May 9, 2024

(54) MOLDING SYSTEM AND METHOD FOR ADDITIVE METAL CASTING

(71) Applicant: Magnus Metal Ltd., Tzora (IL)

(72) Inventors: Yoav Miller, Rehovot (IL); Ido Holcman, Rehovot (IL); Gil Lavi, Ness Ziona (IL); Roi Levi, Rehovot (IL); Hani Farran, Ramat Gan (IL)

(73) Assignee: Magnus Metal Ltd., Tzora (IL)

(21) Appl. No.: 17/983,806

(22) Filed: Nov. 9, 2022

(51) Int. Cl. B28B 1/00; B22C 9/06; B22C 9/12; B22D 23/00; B22F 10/22; B28B 11/08; B33Y 10/00; B33Y 30/00; B33Y 40/20

(52) U.S. Cl. CPC B28B 1/001; B22C 9/06; B22C 9/12; B22D 23/003; B22F 10/22; B28B 11/08; B33Y 10/00; B33Y 30/00; B33Y 40/20

(57) ABSTRACT

A mold construction system is presented for use in additive manufacturing of a metal object. The system comprises: at least one mold provision device controllably operable to form one or more mold regions defining one or more respective metal object regions in a production layer; and a control system operating said at least one mold provision device in accordance with a predetermined building plan. The mold provision device operates, in accordance with said predetermined building plan, to create each mold regions by sequentially forming the following: a metal-facing zone defining a cavity forming the metal object region, and a metal-nonadjacent zone around the metal-facing zone. The metal-facing zone of the mold region is made of a ceramic-based material and is distinct from the metal-nonadjacent zone in at least one of material composition and mold deposition process parameters.

### TECHNOLOGICAL FIELD

The technique of the present disclosure is in the field of additive manufacturing of relatively large objects and relates to a method and system for mold construction for additive metal casting.

### BACKGROUND AND BACKGROUND ART

Casting is one of the oldest material-forming methods still used today. The principal process had not changed since 3200 BC when bronze was melted and poured into a stone mold. Metal casting is defined as the process in which molten metal is poured into a mold that contains a hollow cavity of a desired geometrical shape and allowed to cool down to form a solidified part.

Most of the world's demand for metal casts is addressed nowadays by traditional casting techniques. While automation solutions are applied, traditional casting involves the global production of molds and the global application of molten metal. For example, additive manufacturing techniques are used for mold fabrication with the implementation of mold curing, sintering, or otherwise mold curing (partially or fully) as a global operation before metal pouring. Molten metal is poured into fully fabricated molds.

Currently available metal additive manufacturing technologies address complex design and low volume applications of relatively small-size parts. Scaling from small parts to large parts of hundreds and thousands Kg. is not trivial. In several currently available metal additive manufacturing technologies, size and weight scaling-up involve part deformation, distortion, shrinking, fracture, cracking, and more.

Despite the advantages of metal additive manufacturing, the associated high cost, low throughput, and scaling-up challenges prevent the adoption of additive techniques for widespread industrial use, especially for manufacturing iron and steel parts.

Casting is widely used for industrial manufacturing of large production quantities and sizable parts in a one-piece cast. Metal casting can produce complex shapes and features like internal cavities or hollow sections can be easily formed. Materials that are difficult or expensive to manufacture using other manufacturing processes can be cast. Compared to other manufacturing processes, existing casting is cheaper for medium to large metal quantities, especially for iron and steel casting.

Modern metal casting also has several disadvantages. Patterns and molds are time-consuming and expensive to make. Additive manufacturing processes, such as, e.g., binder jetting, are typically used to create patterns and molds. However, the fabrication of patterns and molds extend the lead time and limit design flexibility for modifications and adaptations. Additionally, minor post-processing or significant additional post-processing operations are needed for certain applications. Furthermore, metal casting is a hazardous activity, as it involves many elements such as furnaces, molds, cooling areas, and additional tooling that are manually operated and exposed, while operating at very high temperatures.

US Patent Publication No. 2020/0206810, assigned to the assignee of the present application, describes a method and an apparatus for additive casting of parts, wherein the method may include depositing, on a build table, a first portion of a mold, such that, the depositing may be performed layer by layer; pouring liquid substance into the first portion of the mold to form a first casted layer; solidifying at least a portion of the first casted layer; depositing a second portion of the mold, on top of the first portion of the mold; pouring the liquid substance into the second portion of the mold to form a second casted layer, on top of at least a portion of the first casted layer; and solidifying at least a portion of the second casted layer. The method may further include pre-heating each casted layer prior to the pouring of an additional casted layer.

### GENERAL DESCRIPTION

There is a need in the art for a novel additive metal casting technique that facilitates high-volume manufacturing with high throughput.

In order to enable high production yield and provide high precision of the casted parts, the mold being produced during the additive metal casting should withstand not only high hydraulic pressure of the molten metal on the mold walls, but also multiple cycles of casted metal heating, which lead to metal expansion, thereby exerting additional pressure onto the mold walls.

As described in the above-mentioned patent publication US2020/0206810, assigned to the assignee of the present application, the additive metal casting can be performed together with additive mold casting. The inventors have identified another problem associated with a need for heating the working area of the object region, to a pre-deposition target temperature needed prior to depositing the metal in the object region. This heating is required to affect bonding of the molten metal with the solidified metal of the preceding metal layers (deposited during previous casting cycles and already cooled down). The pre-deposition target temperature may be below, equal to or above a melting temperature of the metallic object being manufactured. Heating of already solidified metal inside the mold is accompanied by a volume change and exerts pressure on the mold walls during the phase change, causing significant stress inside the mold material and may lead to failures of the mold.

The ceramic-based mold casting process is frequently the preferred casting procedure in casting of metals because it gives a perfect surface quality with intricate details and dimensional stability. In addition, ceramic-based molds provide strength necessary to maintain the shape of the metal object being casted, permeability allowing hot air and gases to pass through the pores within the ceramics and thermal stability to resist cracking on contact with molten metal.

The present disclosure presents a novel mold construction system for use during additive casting of metal objects. The mold construction system provides unique mold regions which are not only configured to define the shape of the metal object, but also to prevent leakage of the molten metal during additive casting, thereby preserving the desired shape of the metal object, increasing thus the casting process yield and safety.

It should be noted that according to the present disclosure, additive metal casting includes fabricating a mold structure concurrently with a metal object structure, where this fabrication is implemented in the layer-by-layer additive manner. The layer is termed here a “production layer”. Each production layer (in some embodiments, except for a lowermost layer) includes one or more “mold regions” each defining and surrounding a respective “object region” of the metal object structure. The closed-loop mold region in the production layer being fabricated defines a cavity into which the molten metal of the object region is deposited. Typically, the first (lowermost) layer includes the closed-loop mold region and a bottom layer of the cavity made solely out of the mold material.

Thus, in the description below, the term “mold region” refers to the mold part/portion within the single production layer. The terms “mold structure” and “mold” are used interchangeably referring to all or part of the stack of mold regions in all or several production layers.

It should be understood that in the general field of mold fabrication by 3D printing, the term “mold” is commonly used to describe a complete mold structure, fully sintered/cured before metal pouring. The technique of the present disclosure deals with additive fabrication (production layer-by-production layer fabrication) of a stack of mold regions where, within each mold region, additive casting of a respective stack of object regions in the cavity being formed by the respective mold region is performed. In this connection, it should be noted that the mold regions of different production layers may or may not be of the same size and geometry since this depends on the specific geometries and sizes of the respective object regions.

The mold construction system of the present disclosure is configured to perform the process by layer-by-layer formation of a stack of multiple production layers. The system is configured to fabricate each production layer by forming the mold region(s), by depositing mold material(s), followed by formation of associated object region(s) by depositing molten metal in each cavity/object region defined by the respective at least one mold region. Each successive production layer is formed after completion of the preceding production layer. The mold regions of the different production layers are therefore cured (fully or partially, or not at all) at different points of time during the production process.

Also, during the additive metal casting, each mold region undergoes transient thermal shocks: heat is provided during the deposition of molten metal into the interfacing object region; in some embodiments, the temperature of the chamber encompassing the build table is increased after mold deposition and before molten metal deposition; during the fabrication of successive mold and object regions in successive production layers, heat from the upper layer dissipates to the under layers. The mold construction system of the present disclosure is therefore configured to design the mold region such that the mold region withstands said thermal shocks.

The mold region construction system and method according to the present disclosure provides the mold region which includes distinct and functionally different mold region zones including a ceramic-based metal-facing zone interfacing with respective object region, and a metal-nonadjacent zone around the respective metal-facing zone.

The mold region construction system and method according to the present disclosure provides the mold region which includes distinct and functionally different mold region zones including a ceramic-based metal-facing zone interfacing with respective object region, and a metal-nonadjacent zone around the respective metal-facing zone.

The metal-facing zone may undergo surface treatment in at least its metal-facing surface. For example, the metal-facing surface may undergo surface shaping, material removal (e.g., of ceramic sags), surface smoothening, coating, curing, partial curing and more. The invention is not limited by the type of surface treatment techniques and systems used for applying the surface treatment. For example, milling, grinding, polishing, heating, coating and like techniques and system may be used.

Thus, according to one broad aspect of the present disclosure, there is provided a mold construction system for use in additive manufacturing of a metal object, the mold construction system comprising: at least one mold provision device controllably operable to form one or more mold regions defining one or more respective metal object regions in a production layer; and a control system configured to operate said at least one mold provision device in accordance with a predetermined building plan;
wherein said at least one mold provision device is controllably operable, in accordance with said predetermined building plan, to create each of said one or more mold regions by sequentially forming the following: a metal-facing zone configured to define a cavity forming the metal object region, and a metal-nonadjacent zone around said metal-facing zone,
wherein the metal-facing zone of the mold region is made of a ceramic-based material and is distinct from the metal-nonadjacent zone of said mold region in at least one of material composition and mold deposition process parameters.

The metal non-adjacent zone of the mold region is configured to provide a mechanical support to the metal-facing zone of said mold region. The metal non-adjacent zone of the mold region may for example comprise a ceramic-based material.

In some embodiments, the at least one mold provision device is controllably operable to create the metal non-adjacent zone of the mold region comprising a crisscross pattern. For example, the mold provision device is controllably operable to create the metal non-adjacent zone of the mold region in multiple iterations of material deposition to form said crisscross pattern. In some other embodiments, the mold provision device is controllably operable to create the metal non-adjacent zone of the mold region comprising a curly pattern.

The mold provision device may be controllably operable to create the metal non-adjacent zone of the mold region with enlarged surface area and reduced material density, allowing fast heat and vapor transport from the metal-facing and metal-nonadjacent zones of the mold region; and/or to create the metal non-adjacent zone of the mold region configured to enable fast formation of said metal-nonadjacent zone of the mold region.

In some embodiments, the mold provision device is configured and operable with varying one or more of mold material deposition parameters and conditions to form the mold region, prior to deposition of the molten metal to form the respective object region of the current production layer. The varying one or more mold material deposition parameters is/are selected to create said metal-facing zones and said metal-nonadjacent zone of the mold region with the reduced material density capable of undergoing cyclic thermal shocks associated with said additive deposition of the molten metal of the object region. For example, the reduced material density of each the metal-facing zone and the metal-nonadjacent zone is defined by porosity of the mold material thereof, e.g. reduced material density is defined by the porosity with pore sizes substantially not exceeding 60 μm.

Preferably, the ceramic-based material is in green state.

For example, the ceramic-based material is characterized by viscosity of at least 40K cps.

In some embodiments, the metal-facing zone and the metal-nonadjacent zone of the mold region comprise, respectively, first and second different mold material compositions.

The mold provision device may be configured and operable to provide the mold region configured such that the metal-facing zone, by a non-metal facing side thereof, is at least partially adhered to the metal-nonadjacent zone.

In some embodiments, the mold region is configured with the metal-facing zone including a first sub-zone which by its metal-facing side directly interfaces with the object region and a second sub-zone around said first sub-zone at an opposite side of the first sub-zone. The first sub-zone is configured as an inner wall made of a refractory compressible ceramic-based material operating as a metal-facing thermally isolating wall for the second-sub-zone. For example, the second sub-zone of the metal-facing zone is made of a plastic material.

In some embodiments, the mold region further comprises an enclosure around the metal-nonadjacent zone. The enclosure may be spaced from the metal-nonadjacent zone by a gap filled with a mold material composition having higher compressibility than said metal-nonadjacent zone.

The mold material composition having higher compressibility may comprise one or more of the following: compressible sand, ceramic-based material, compressible ceramic-based material, porous ceramics, ceramics by spraying, spheres, negative thermal expansion materials, reversibly compressible plastics, nanostructures, layered materials.

In some embodiments, the mold provision device is controllably operable in accordance with said building plan which is further indicative of two or more of the following: geometric layout of the one or more object regions in each of the production layers; material, geometrical properties and arrangement of the metal-facing and metal-nonadjacent zones of each mold region in each of the production layers; surface treatment parameters and conditions of surface treatment of the mold region; and synchronization data for the mold regions and object regions formation in the production layers.

The mold construction system may also include a surface treatment system configured and operable to apply one or more surface treatments to the mold region, e.g. apply temperature treatment to the mold region (e.g. to provide material hardening in the mold region), perform mechanical surface treatment of at least a part of the mold region (e.g. of a surface of the metal-facing zone by which it interfaces said object region).

In some embodiments, the mold deposition device comprises one or more traveling mold depositors, each traveling in a horizontal plane according to a predetermined trajectory and being associated with one or more mold material reservoirs.

The mold deposition device may comprise one or more extruders each in fluid communication with said one or more traveling depositors.

The traveling depositor may comprise at least one of the following: stirrers, tubing, and tubing loop configured to perform continuous circulation of the mold material not currently involved in deposition process.

The mold construction system may include a build table configured to be placed in a temperature-controlled environment. The system may be configured to provide relative displacement between said one or more traveling depositors and the build table

In some embodiments, the mold construction system is configured and operable to create the mold region of a current production layer on top of either at least a part of a preceding mold region of a preceding production layer or on at least a part of a preceding object region of the preceding production layer, depending on a surface relief of the metal object region being manufactured.

According to another broad aspect of the present disclosure, it provides a production part comprising: a stack of production layers, each of the production layers comprising: one or more object regions of a metal object, each object region being surrounded by a mold region, wherein the mold region comprises a metal-facing zone, and a metal-nonadjacent zone around the metal-facing zone, such that a surface of the metal object in said object region and a metal-facing surface of the metal-facing zone of the mold region are physically coupled between them, said metal-facing zone being distinct from the metal-nonadjacent zone of said mold region in at least one of material composition and mold deposition process parameters.

According to yet another broad aspect of the present disclosure, it provides an additive casting system for additively casting of a metallic object by producing multiple production layers having mold regions and object regions within cavities defined by the mold regions, one current production layer after the other on a movable build table up to a top production layer. The additive casting system comprises: the above-described mold construction system, and an object construction device configured and operable to construct each current production layer by depositing molten metal in each of one or more object regions defined by each of the respective one or more mold regions in said current production layer.

The object construction device may comprise one or more molten metal depositors; and a control system configured to operate said one or more molten metal depositors in accordance with a predetermined building plan which is indicative of the following: geometric layout of the one or more object regions in each of the production layers; and synchronization data for the mold regions and object regions formation in the production layers.

The object construction device may be configured and operable to create the object region of a current production layer on top of either at least a part of a preceding mold region of a preceding production layer or on at least a part of a preceding object region of the preceding production layer, depending on a surface relief of the metal object region being manufactured.

The present disclosure, in its yet further broad aspect, provides a method for use in additive manufacturing of a metal object. The method comprises: constructing successive production layers, each including a number of mold regions defining a respective number of metal object regions, wherein the constructing of each production layer is controllably performed in accordance with a predetermined building plan, by carrying out the following: for each production layer, prior to deposition of molten metal material in the number of object regions, creating said number of mold regions, where each of the mold regions is created by depositing one or more mold materials to sequentially form the following: a metal-facing zone configured to define a cavity forming the metal object region, and a metal-nonadjacent zone around said metal-facing zone, wherein the metal-facing zone of the mold region is made of a ceramic-based material and is distinct from the metal-nonadjacent zone of said mold region in at least one of material composition and mold deposition process parameter.

As described above, in some embodiments of the invention, surface treatment is applied—and followed by molten metal deposition, while the mold materials are in their green body state. The mold construction technique of the present disclosure preferably uses mold materials in their green body state allowing to significantly shorten manufacturing times. The time needed for full sintering is obviated. The global mold removal step upon casting completion is simplified, comparing the removal of a fully-sintered mold structure. Some mechanical properties and specifically compressibility of ceramics can be obtained in an easier manner in the green state. However, the use of ceramic mold material in the green state involves significant challenges such as lower tensile strength and higher porosity comparing fully-sintered ceramics, and material sagging upon deposition. Aspects of the present disclosure addresses green state challenges: for example, lower tensile strength is addressed by providing support zones or using different materials in different mold zones; sagging in the pre-cured state is addressed by surface treatment for example, in the metal facing zones of the mold regions; higher porosity is addressed for example, by surface treatment and/or coating of the metal facing zones of the mold region.

In some embodiments, the metal-facing zone is dispensed as a closed-loop tube-shaped paste (denoted as “paste tube” or “contour”), and the metal nonadjacent zone is dispensed as a second tube, supporting the metal-facing tube (denoted “double-tube” or “double contour” configuration).

In some embodiments, larger and wider support zone is required. In order to improve throughput and other operational parameters, the dispensing plan for the metal-facing zone and the metal-nonadjacent zone differs in the area density parameter: the metal-facing zone is dispensed as a closed-loop tube-shaped paste, and the metal nonadjacent zone is dispensed as a tube in a curly pattern, leaving a pre-determined airgaps between paste tube sections.

In some embodiments, the curly dispensing pattern of the metal-nonadjacent zone in positioned at a predetermined direction in one dispensing iteration, and at a different direction at the next dispensing iteration. As a result, successive metal-nonadjacent zones constructed in successive dispensing iterations, give rise to a mold structure with crisscross pattern (denoted “crisscross” configuration).

As also described above, the crisscross pattern or curly pattern of the metal-nonadjacent zone provides (i) mechanical support to the metal-facing zone, (ii) enlarged surface area of the metal-non-adjacent zone, thereby allowing fast heat and vapor transport from the mold region during the transient thermal shocks and short drying periods of the mold region, and (iii) fast construction of the mold region, thereby shortening the overall construction time and increasing production throughput.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIG. 1A schematically illustrates, by way of a block diagram, the additive mold construction system of embodiments of the present disclosure;

FIG. 1B more specifically exemplifies the configuration and operation of the mold construction system of embodiments of the present disclosure;

FIG. 2A schematically illustrates, by way of a flow diagram, the additive mold construction method according to embodiments of the present disclosure implemented concurrently with the additive metal object construction;

FIGS. 2B to 2F illustrate the principles of the mechanism utilized in the technique of the present disclosure for the additive mold construction, wherein FIG. 2B shows typical stress-strain curves of ceramics, metals and polymers; FIG. 2C shows a stress-strain curve of a brittle material under tensile and compressive stresses; FIG. 2D shows a stress-strain curve of a ceramic material more resistant to compression than to tensile stress; FIG. 2E is a schematic diagram showing the pressure exerted by molten metal on the mold wall and the consequent stresses developing within the mold wall; and FIG. 2F shows schematically stress-strain curves corresponding, respectively, to strong, tough and ductile materials;

FIG. 2G shows the steps of the typical thermal treatment of ceramic-based mold material including green body stage, de-binding and sintering;

FIG. 3A shows a timeline of known in the art mold construction processes;

FIG. 3B exemplifies a timeline of the mold construction processes according to the technique of the present disclosure;

FIGS. 4A to 4F show examples of mold regions fabricated according to the technique of the present disclosure, wherein:

FIG. 4A exemplifies a mold region including a metal-facing zone (defining a cavity forming a metal object region) and a metal-nonadjacent zone around the metal-facing zone;

FIG. 4B exemplifies a mold region, which includes a metal-facing zone and a metal-nonadjacent zone which have a double contour configuration;

FIG. 4C exemplifies a mold region including a metal-facing zone and a metal-nonadjacent zone, where the metal-facing zone includes two sub-zones;

FIGS. 4D and 4E show partially constructed mold regions, each including metal-facing and metal-non-adjacent zones and an enclosure around the metal-nonadjacent zone spaced therefrom by an air gap (which is to filled by a filler material) and in which the metal-nonadjacent zone or a sub-zone thereof is formed with crisscross pattern or curly pattern, where FIG. 4D shows the mold region having a single metal-facing zone and FIG. 4E shows the mold region including two metal-facing zones defining a cavity for a ring-like metal object region between them, and two respective metal-nonadjacent zones, one being a mold insert; and

FIG. 4F shows the completely fabricated mold region configured generally similar to that of FIG. 4D;

FIG. 5 show a few examples of various configurations of metal-nonadjacent zone or sub-zone thereof (directly interfacing the metal facing zone) formed with crisscross pattern or curly pattern;

FIG. 6 shows a portion of a production part comprising a stack of production layers exemplifying that, depending on a surface relief of the metal object region being manufactured, the mold region of a current production layer is not necessarily completely aligned with a mold region of a preceding layer, but rather may be located on top of at least a part of the mold region of the preceding production layer or on top of at least a part of an object region of the preceding production layer.

### DETAILED DESCRIPTION OF EMBODIMENTS

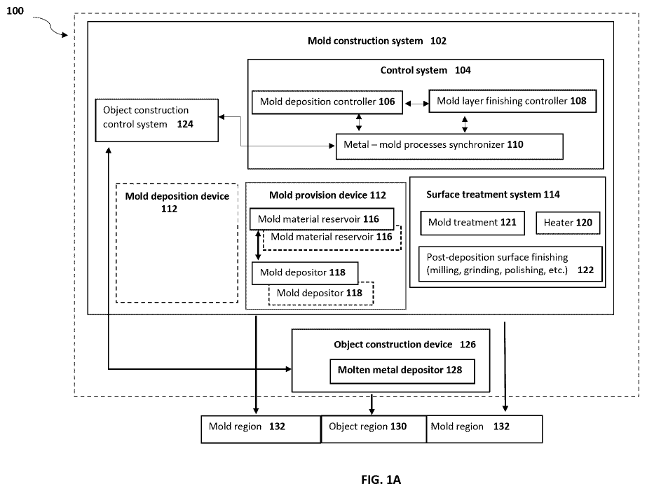

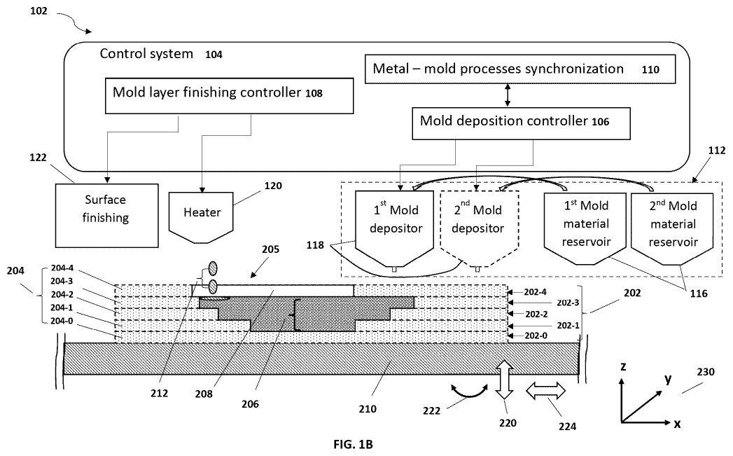

Reference is made to FIG. 1A which schematically illustrates, by way of a block diagram, a mold construction system 102 configured and operable according to embodiments of the technique of the present disclosure. The mold construction system 102 is typically a part of an additive metal casting system 100 which also includes an object construction system/device 126.

It is to be understood that the construction and operation of the object construction device 126 do not form part of the present disclosure and therefore are not described herein in details, except to note the following: The operation of the mold construction system 102 to layer-by-layer form the mold is properly synchronized with operational cycles of the object construction device 126 (via communication with an object construction control system 124) to additively create production layers, each including metal in an object region 130 surrounded by a mold region 132. It should be understood that the object design defines the number of object regions surrounded by the respective mold regions.

The object construction device is preferably configured and operable as described in the above-mentioned US20200206810, and/or in U.S. patent application Ser. Nos. 17/744,686, 17/748,069, assigned to the assignee of the present application, which are incorporated herein by reference with respect to specific not limiting examples of the object construction device and its associated object construction control system 124.

The mold construction system 102 includes inter alia a control system 104 controlling the operation of one or more mold provision devices 112 and a surface treatment system 114. The control system 104 is a computerized system including inter alia a mold deposition controller 106, a mold layer finishing controller 108, and a metal-mold processes synchronizer circuit 110. The latter is in data communication with the object construction control system 124.

The one or more mold provision devices 112 are controllably operable to deposit mold material to form the mold region 132 defining the object region 130 in a production layer. The object region 130 is configured to receive molten metal being deposited by a molten metal depositor 128.

The mold provision device 112 is configured and operable by the mold deposition controller 106, in accordance with a predetermined building plan of successive formation of multiple production layers. In some embodiments, the mold provision device 112 is configured to construct each mold region 132 in each production layer by performing deposition of variable compositions of the mold material in different region zones (metal-facing and metal-nonadjacent zones) of the mold region, prior to depositing the molten metal to form the object region 130 of the current production layer. In some embodiments, the mold provision device 112 constructs the mold region by performing one or more mold deposition iterations.

Each mold provision device 112 may include one or more mold material reservoirs 116 connected via feeding line(s) to one or more traveling mold depositors 118. Each mold depositor 118 is driven (by a suitable drive mechanism which is not specifically shown) for movement in a horizontal plane along a predetermined trajectory according to the building plan.

The mold depositor 118 may be of any known suitable configuration, which does not form part of the present disclosure and therefore need not be specifically described except to note the following. Such mold depositor is typically in the form of one or more extruders/print heads, and each is in fluid communication with the one or more mold material reservoirs 116. It should be noted, although not specifically shown, that since the mold material is typically a relatively viscous material, the mold provision device 112 (e.g., traveling mold depositor(s) 118 and/or the feeding line(s)) may include stirrers and/or tubing and/or tubing loop configured to perform continuous circulation of the mold material which is not currently involved in deposition process.

According to some embodiments of the present disclosure, mold materials include mold materials in paste form, powder form, granular form, slurry form, and mold materials mixed with binders, releasing agents, activating agents, UV absorbing particles, crosslinking agents, heat-absorbing particles, or other additives to facilitate mold fabrication and use. According to embodiments of the present disclosure, mold materials include, but are not limited to ceramics (e.g., zirconia, alumina, magnesia, etc.), sand, clay, metallic powders, and any combination thereof

In the description below, the mold material is at times termed as ceramic-based material, but it should be understood that the principles of the present disclosure are not limited to this specific example, as well as not limited to any type of mold material. The properties of the mold material being used are taken into account, together with those of the metallic material and the building plan, to design the preferred arrangement of the different zones of the mold region and preferred configuration of the metal-nonadjacent zone.

In some embodiments, two material reservoirs 116 may be used for ceramic-based material. The use of two reservoirs may be favorable to make the mold construction process more efficient in time, when a large reservoir, which may be positioned remotely from the production area, is configured in advance to provide proper wetting for a large amount of ceramic-based material (which requires time) under constant mixing. This large reservoir may be in fluid communication (by pipes) with a smaller reservoir, which may be kept under constant mixing, wherein the smaller reservoir is in connection with the mold depositor 118 and possibly also moved together with the mold depositor 118 on the production table to form the predetermined mold regions 132.

The mold construction system 102 may further include a surface treatment system 114. The surface treatment system is configured and operable to apply one or more surface treatments to the mold material in the mold region and may include one or more heaters 120; mold treatment device(s) 121, and a post-deposition surface finishing system 122.

The heater 120 is operable to apply temperature treatment to the mold material in the mold region to harden the mold material, and in some embodiments, may be configurable to apply the temperature treatment to the mold region after each of one or more mold deposition iterations.

In some embodiments, heater 120 may be realized as a common system that provides heating to one or more of the object construction system 126 or part thereof, a building table (not shown), and a production chamber accommodating the mold construction system 102 and object construction system at least during mold construction and object construction, respectively (not shown).

For another example, in embodiments where the mold material is in the powder form, the mold treatment device 121 may include a curing system to cure the mold using any known suitable technique, such as thermal curing, UV curing, gas curing, etc. Other mold treatments that might be suitable to be used in the mold creation may include any one of the following: microwave irradiation, UV irradiation, arc-jet, laser irradiation, ultrasonic vibration, vacuum drying, chemical agent treatment, exposure to electromagnetic field, exposure to a gaseous atmosphere, and any combination thereof. The post-deposition surface finishing system 122 may be configured to perform e.g., mechanical surface treatment of at least a portion of the mold region, or on surfaces of the mold region facing the object region, e.g., milling, grinding and/or polishing.

It should be noted that mold post-deposition surface finishing is not limited to mechanical surface treatment. Several mold post-deposition surface treatments may be applicable to any portion of the mold region (i.e., not only to the metal-facing wall of the metal-facing zone): hardening using e.g., UV light, smoothing using e.g., laser induced melting and others, as described below with reference to FIG. 1B.

Reference is made to FIG. 1B showing more specifically the exemplary configuration and operation of the above-described mold construction system 102 according to embodiments of the present disclosure. In the figure, a cross section view of a part of an object-and-mold structure 205 is shown, which is formed by several successively produced/deposited production layers 202-0 to 202-4.

Structure 205 includes a metal object 206 within (enclosed by) its mold structure which is in the process of being additively cast on a build table 210. The build table is configured to be placed in a temperature-controlled environment (for example, a chamber, not shown here). Relative movement is provided between the build table 210 and elements of a production system (e.g., mold depositor 118 and metal deposition device which is not shown here) used for the fabrication of the production layers.

The relative movement may be provided on command from the control system 104 (or control system 124 associated with the metal deposition process) and can be realized side-to-side (in an x-direction 224), front-to-back (in a y-direction), as well as up and down (in a z-direction 220), and possibly also rotated clockwise and counterclockwise 222 with respect to a coordinate system 230. Typically, for casting large, unwieldy, and heavy objects, the displacement of the build table 210 may be limited to relative movement in the z-direction.

In some embodiments, the build table 210 is moved along the z-direction between the production layers in order to keep a working distance between the material depositor(s) and the surface of the working area. In some embodiments, the build table 210 is moved between the construction of the mold region and the production of the object region of the current production layer. In some embodiments, the x-y relative motion may be accomplished by moving the mold depositor(s) 118, the heater(s) 120, and the mechanical surface finishing unit(s) 122 while keeping the build table 210 stationary.

The additive casting of the technique of the present disclosure proceeds in accordance with a predetermined building plan of successive formation of multiple production layers (202-0 to 202-4). In the non-limiting example shown in FIG. 1B, in production layers 202-0 to 202-3 both the mold construction and the metal casting are accomplished, whereas in the current production layer (202-4) molten metal 212 is being deposited into object region 208 after the mold region 204-4 of the current production layer—defining object region 208—was fabricated. Typically, one or more bottom production layers (e.g., 202-0) are dedicated to mold material forming the lower surface for the successive production layers.

In this specific not limiting example, layers 202-0 to 202-4 include mold regions 204-0 to 204-4, wherein the bottom layer 204-0 serves as the base layer, and the successive production layers (204-1, 204-2, 204-3, and 204-4) include the mold regions defining mold cavities forming the object regions for receiving molten metal. The mold regions 204-0 to 204-4 of layers 202-0 to 202-4 are shown with dotted lines representing the interfacing surfaces between them. This is to indicate that the mold regions of the production layers were fabricated at different production cycles and are in tight contact and adhered one to another.

As also shown in the figure, the mold construction system 102 includes the control system 104, mold provision device 112 including mold material reservoirs 116 and mold depositors 118 receiving mold material from the reservoirs 116, and additional mold fabrication devices, e.g., a heater 120 and mechanical surface finishing devices 122.

The principal operation of the mold region fabrication is carried out iteratively within the current production layer, on one or more locations (single location being shown in the example of FIG. 1B), by (sequentially) providing relative displacement between the mold provision device 112 and the build table 210 and additively dispensing the mold materials to form the mold region (e.g., 204-4) under the control of the mold deposition controller 106. In some embodiments, post-deposition treatments (e.g., mold layer hardening, inner surface treatment, e.g., milling, grinding, polishing) are performed under the control of the mold layer finishing controller 108, as described above.

The casting system 100 also includes an object construction system 126, which, as shown in FIGS. 1A and 1B, includes a molten metal depositor 128. A relative displacement between the molten metal depositor and the build table 210 may be provided, e.g., the molten metal depositor may be movable. The molten metal depositor 128 may include crucibles, remote molten metal reservoirs, wire or rod stock for melting, powder for melting or combinations thereof.

It should be noted, although not specifically shown, that the object construction system 126 also includes its controller (which is a part of or operates in communication with the control system 104 of the mold construction system 102), as well as surface treatment device(s) including one or more movable heaters (performing pre-heating and post-heating of the object region). Generally, during additive casting processes, the movable units are driven for movements in the x-y plane as well as in the z direction, and have degrees of freedom in horizontal motion, vertical motion, and rotation.

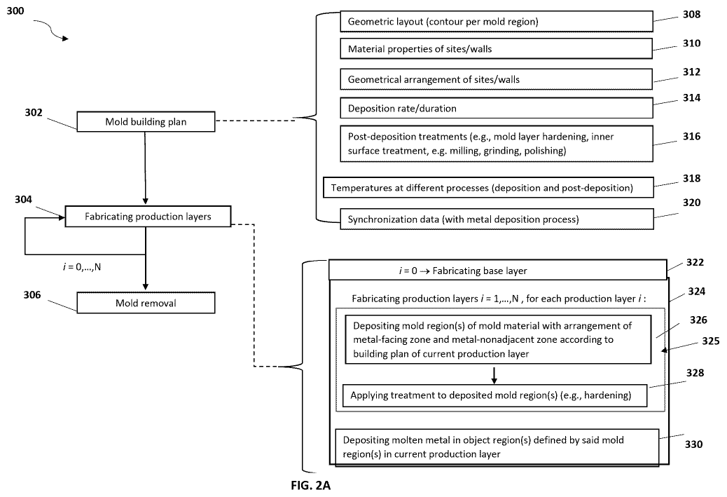

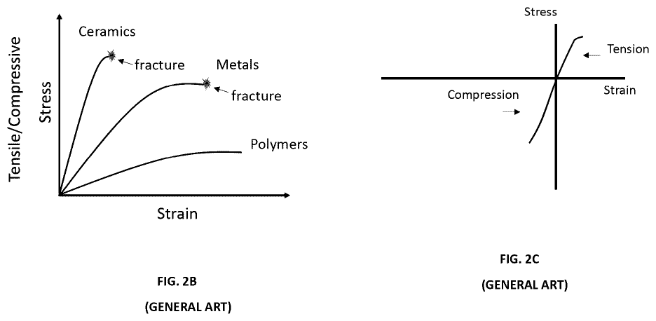

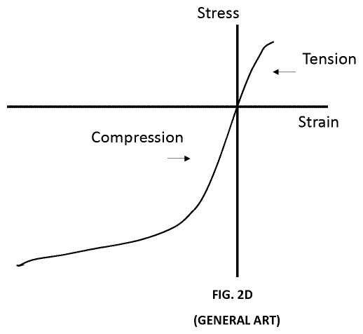

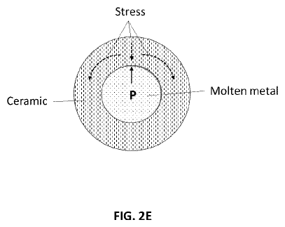

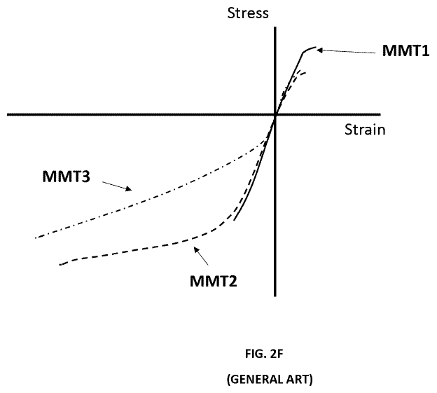

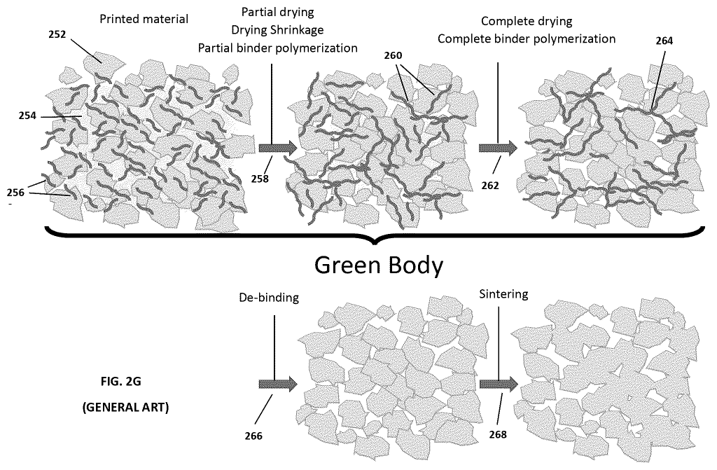

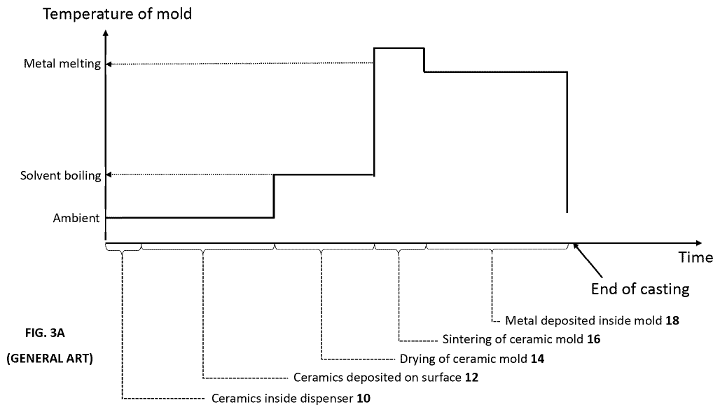

Reference is made to FIG. 2A which schematically illustrates, by way of a flow diagram 300, an additive mold construction method according to embodiments of the present disclosure providing the mold region configured as described above, i.e. comprising an arrangement of metal-facing and metal-nonadjacent zones, configured with different mechanical properties such that metal-facing zone has higher compressibility (higher ability to absorb energy of compressive stress) than at least a sub-zone of the metal non-adjacent zone. This arrangement is selected in accordance with properties of the metal object to be created and molten metal deposition used for creation of such object.

The method includes iteratively fabricating, based on mold and object building plans 302, a set of vertically stacked production layers (i=0, . . . , N) one upon another (step 304), which, once the final production layer is completed, form the entire cast mold structure surrounding the metal object. The mold structure is then removed (step 306).

The mold building plan 302 includes the necessary information/parameters to allow successive formation of multiple production layers, and for each production layer, formation of one or more mold deposition iterations in each mold region associated with a respective object region. Such mold deposition of the mold region (e.g., via iterations) may be completely performed prior to depositing the molten metal to form the respective object region of the current production layer.

In particular, the mold building plan 302 includes geometric data indicative of the geometry/shape of the metal-facing zone of the mold region 308, i.e., contour per metal-facing zone determined by the required finished surface of the metal object region; and parameters (geometrical and material parameters) of the configuration of the metal-facing and metal-con-adjacent zones as well as geometric layout of the mold region structure 312 (e.g., alignment of mold and object regions of adjacent production layers).

The mold building plan 302 also includes material-related data 310 indicative of the properties of one or more materials used in the formation of the mold (e.g., properties of the various zones and sub-zones of the mold regions in the production layers). For example, increasing the toughness/compressibility of the mold region may be associated with porosity. In this example, the porosity may be accomplished by introducing gas (e.g., bubbling) into the mold material of the zone or sub-zone of the mold region, thereby making it more porous and therefore tougher as compared to the neighboring zone or sub-zone of the mold region. Additionally, or alternatively, porosity of the mold material may be achieved by treating selected sites in the mold region by a chemical agent. Applicable chemical agents may be foaming agents (SDS—Sodium Dodecyl Sulphate, and Calcium Carbonate as an example).

Further, the mold building plan 302 includes data indicative of the mold deposition process to sequentially form multiple production layers. This data includes a number of mold deposition iterations to create the mold region of each production layer.

Typically, the building plan also includes rates and durations of the mold material deposition 314.

The building plan may also include data indicative of the temperature parameters/conditions of one or more post-deposition treatments 316. The post-deposition treatment(s) may be of the type aimed at mold hardening (e.g., by heating), surface treatment, in particular inner surface of the mold region by which it faces the object region (e.g., by milling, grinding and/or polishing).

Further typically included in the building plan is data indicative of the temperature parameters/conditions at different processes 318 (including the mold deposition process and post-deposition treatment(s)). These include, for example, the temperatures of material reservoir(s), the deposition devices, and the building table during the mold deposition, and the temperature right after the mold deposition.

Further, typically included in the building plan is data indicative of the temperature parameters and other conditions at different processes 318 (including the mold deposition process and post-deposition treatment(s)). These include, for example, the temperatures, pressure, and environmental conditions (gas composition) of material reservoir(s), the deposition devices, and the build table during the mold deposition, and the temperature right after the mold deposition.

It should be noted that the mold deposition and metal deposition used for creation of the mold region and object region, respectively, are successively performed during creation of each production layer and have different process parameters and timing. Therefore, the building plan includes or defines synchronization data to properly synchronize the mold deposition procedure with the metal deposition process 320, which is critical for the additive mold and object casting.

Typically, the fabrication of the production layers may start with the fabrication of a base layer (i=0) on a build table 210 (e.g., mold production layer 202-0 in FIG. 1B)—step 322. The stage 324 of fabrication of each successive production layer (i=1, . . . , N) includes the mold region creation 325 which begins with depositing mold region(s) of mold material while creating the arrangement of metal-facing zone and metal-nonadjacent zone according to the building plan of the current production layer (step 326) which may include multiple deposition-iterative procedures; and successively applying post-deposition treatment(s) to each deposited mold region (e.g., milling, polishing, hardening) (step 328). This is followed, in a synchronized manner, by the molten metal deposition in each respective object region defined by the mold region in current production layer (step 330).

It should be noted that in some embodiments, an additional post-treatment is used including at least partial surface finishing of the deposited mold region(s) of the production layer (step 328). This is in some embodiments performed before the mold region is cured or hardened, whereas in some other embodiments such surface finishing is performed after the mold region is hardened.

In some embodiments, the height of the object region in a production layer is in the range of 4-8 mm, and the height of the corresponding mold region in the production layer is in the range of 6-10 mm.

The mold region in a production layer may be realized by a single deposition or by two, three or more deposition iterations. For example, a production layer of 6 mm height may be realized by two mold deposition iterations of a paste tube with a 3 mm height.

The appropriate selection of mold materials is generally done according to the suitability of the different mechanical properties of the different mold region zones to the application at hand, (e.g., matching the compressibility of the mold material to the expected thermal expansion of the metallic object material). The following is a qualitative description of relevant mechanical properties.

Reference is now made to FIGS. 2B to 2F supporting the explanations and associated terms used herein underlying the principles of the technique of the present disclosure. FIG. 2B illustrates typical tensile/compressive stress-strain curves for three classes of materials, ceramics (typically used for mold creation), metals (used for object creation), and polymers that can be used in the mold material(s). Stress-strain curves visually display the material's deformation in response to a tensile, compressive, or torsional load. The stress strain curve for a ceramic material is almost straight line up to a yield point, both under tensile or compressive stresses, soon after which the ceramic suddenly reaches the fracture point and breaks. Metals are ductile materials, exhibiting plastic deformation (during the flattened part of the curve) before fracture, whereas ceramics exhibit negligible plastic deformation under external loading (hardly any flattened part in the stress-strain curve in FIG. 2B). This property of ceramic materials justifies their definition as brittle (opposite of ductile) materials. FIG. 2C shows a representative (qualitative) stress-strain curve of a brittle material under tensile and compressive stresses where the opposite signs of the strains under tensile/compressive stresses are clearly indicated.

Though, ceramics, being brittle materials, have compressive strengths about ten times higher than their tensile strength (strength is defined as the maximum stress in the relevant tension/compression quadrants of the stress-strain diagram). The discrepancy between tensile and compressive strengths is in part due to the brittle nature of ceramics. When subjected to a tensile load, ceramics, unlike metals, are unable to yield and relieve the stress. The tensile strength of ceramics (as well as glasses) is low because the existing flaws (internal or surface cracks) act as stress concentrators, resulting in a tendency of a material to fracture/crack with very little or no detectable plastic deformation beforehand. In compression, however, the flaws in the ceramic material do not cause stress concentrations or crack propagation, as they do in tension. For example, under a compressive load a transverse crack in a ceramic material may tend to close up and so cannot propagate.

For some embodiments, ceramics or ceramics-based materials are used as mold material during metal casting due to their ability to withstand the high temperatures of molten metals in addition to their very high modulus of elasticity (Young's modulus).

FIG. 2D shows an example of a stress-strain curve of a ceramic material which is more resistant to compressive stress (has higher toughness) than to tensile stress. This can be judged by its high compressibility under compressive stress.

The ability of a material to deform under compression (plastically or elastically) is termed compressibility. The ability of a material to absorb energy in the process before fracture is termed toughness. It should be noted that ductility is a measure of how much something deforms plastically before fracture, but just because a material is ductile does not make it tough. The key to toughness is a good combination of strength (tensile/compressive) and ability to deform (under compression and/or tension). A material with high strength (tensile/compressive) and high ductility has higher toughness than a material with low strength and high ductility. Young's modulus measures a material's rigidity. The more rigid the material, the higher its modulus of elasticity. A material is considered to exhibit brittle fracture if its behavior is elastic virtually up to failure. Young's modulus does not depend on faults (microcracks) in the material. Toughness, on the other hand, is a measure of a material's resistance to crack propagation. Unlike mechanical strength, toughness is independent of fracture-initiating flaws to (microcracks), though it depends on the microstructure of the material.

In order to be tough, a material must be both strong and ductile. Therefore, one way to measure toughness is by calculating the area under the stress strain curve from a tensile test. This value (the area under the stress strain curve) is simply called “material toughness” and it has units of energy per volume. Material toughness equates to a slow absorption of energy by the material. Toughness tends to be small for brittle materials, because elastic and plastic deformations allow materials to absorb large amounts of energy. Thus, brittle materials, when subjected to stress, break with little elastic deformation and without significant plastic deformation. Brittle materials absorb relatively little energy prior to fracture, even those of high strength.

The mold fabricated according to the principles of the technique of the present disclosure (i.e., including metal-facing and metal-nonadjacent zones) is particularly suitable for use in additive metal casting, which involves multiple iterations of molten metal deposition, as well as multiple rounds of heating portions of the solidified metal bulk prior to depositing the next metal layer. As shown in FIG. 2E, in such a process, the previously deposited molten metal unavoidably expands during heating, thereby exerting pressure P on the mold region from inside, in addition to the pressure exerted by a portion of the molten metal during casting of the successive production layer. It is important to note that in addition to the axial stresses (tensile and compressive) being developed inside the ceramic mold due to the molten metal, circumferential tensile stresses develop inside the ceramic mold all along the mold perimeter.

FIG. 2F shows strain-stress curves of mold material types, MMT1, MMT2, and MMT3, which differ from one another by their mechanical properties, in particular their tensile strength TS, toughness TH, and compressibility C. The first-type mold material, MMT1, is the strongest/stiffest of the three, characterized by highest tensile strength TS₁ and highest modulus of elasticity. It has the lowest toughness TH₁ and nearly zero (minimal) compressibility C₁ as can be judged from the lowest strain values achieved by this material under compressive stress compared to the MMT2 and MMT3 material types. The second-type mold material, MMT2, has lower tensile strength TS₂ as compared to material MMT1 (TS₂<TS₁), but higher toughness TH₂ as compared to MMT1 (TH₂>TH₁). Material MMT2 has significantly higher compressibility C₂ than material MMT1 (C₂>>C₁), and notably, MMT2 has both an elastic regime where the compressibility C₂ is reversible (in the linear part of the strain-stress curve) and a plastic regime where the compressibility C₂ is mostly irreversible. The third-type mold material, MMT3 has about the same toughness TH₃ as material MMT2 (TH₃≈TH₂) as judged from the similar area under the strain-stress curves. However, the compressibility C₃ of material MMT3 is mostly irreversible, as judged from the non-linear shape of the strain-stress curve.

The mold configured according to embodiments of the present disclosure is manufactured by an additive deposition of mold material e.g., ceramic-based material. It is configured to withstand the pressure exerted during metal casting and preserve the integrity of the mold by significantly decreasing the number and sizes of cracks that can be formed within the mold by the action of the pressure exerted by the molten metal.

The inventors understood that the ceramic material suitable for mold manufacturing is to be of high toughness, i.e., optimal combination of strength and flexibility/ductility. However, this material is also to be tolerant to very high temperatures. The additive casting technique of the present disclosure uses repeated cycles of manufacturing successive production layers, the manufacture of each production layer including mold and metal depositions in mold and object, regions, respectively. Such process includes repeated cycles of transient temperature changes, as will be described in detail below.

FIG. 2G shows the steps of thermal treatment of ceramic-based mold material according to the known in the art process. Initially, the deposited mold material contains ceramic particles 252, solvent 254 and monomer particles of a binder 256. Once the mold material is extruded, it may undergo various curing stages indicated by arrows 258, 262, 266, 268 in FIG. 2G. The curing of the mold material may be active (e.g., by heating) or passive (e.g., by letting the material to dry). The first curing stage 258 includes partial drying of the mold material during which the solvent 254 partially evaporates and the mold material shrinks due to partial binder polymerization, creating polymer dimers 260. In the second curing stage 262, the solvent 254 completely evaporates and the binder 256 undergoes complete polymerization to create a polymer network 264. Up to this stage, the mold material is known to be in the “green body” state. Further curing of a green body 266, typically during active heating of the mold material, causes de-binding, i.e., removal (e.g., burn off) of the organic components. During the last curing stage 268 the mold material is sintered, i.e., fusion of the ceramic particles 252 occurs forming a compact, solid and strong mold.

Due to the evaporation or decomposition behavior of organic components at different temperatures, a tailored temperature profile has to be used to obtain crack-free ceramics after thermal post processing. Ceramic materials in their sintered state may be sensitive to abrupt temperature changes and therefore their stability may be compromised before completion of the casting of the metal object. typically, sintering process is long and requires heating and time.

The inventors have found that using the ceramics in its green state (i.e., before de-binding and sintering) is beneficial to the casting process, especially since in the green state ceramics may be able to better absorb the strain energy developed due to metal expansion during various casting stages. Yet, even during the additive metal casting used in the present disclosure (i.e. successive creation of the mold region and its associated object region while using green state mold material and no sintering procedures) the mold regions experience very high temperatures (e.g., 1000-1500° for gray iron), although transiently, as will be described in detail below.

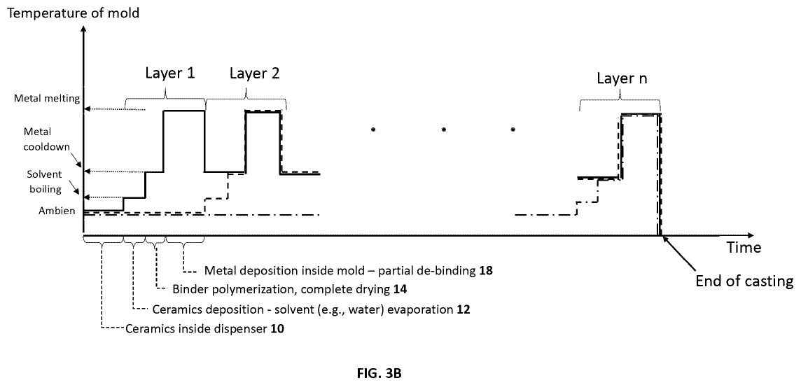

FIG. 3A describes the timeline of known in the art additive mold construction processes for forming a global mold. Typically, during the mold printing processes, the ceramic-based material is in a state of a paste inside a dispenser and is kept under constant temperature, typically at ambient temperature in the range of 16°-17° (stage 10). It is then printed/deposited on a surface using an injector/syringe, while both the ceramics and the surface are kept under the same constant temperature, i.e., ambient temperature typically in the range of 16°-17° (stage 12). Special care is taken to provide steady state (thermodynamic) conditions to ensure that all physical parameters (e.g., density, texture, viscosity) of the ceramic material are stable during the deposition process. In the next step, the mold is dried (stage 14) at the boiling temperature of the solvent and sintered (stage 16) at temperatures that may be higher than the metal melting temperature. After the mold is complete, it is transferred into the casting location. Metal is deposited inside the mold (stage 18) and let to cool down inside the mold. The mold is then removed. The long preparation time of the mold makes manufacturing production rates for the over whole casting process too slow.

The timeline of additive metal casting according to the principles of the present disclosure is shown in FIG. 3B with specific reference to processes related to mold construction. The additive manufacturing of a metal object comprises constructing successive production layers, to perform, for each production layer, formation of one or more mold regions, defining one or more respective metal object regions (depending on the configuration of the object being manufactured), prior to depositing the molten metal in said one or more object regions. The build table on which both the mold and the metal are deposited is kept at a relatively high temperature (400°-600°). Metal processing may involve additional heating of the metal in the object region. Thus, the sequentially deposited object regions of the cast metal are metallurgically bonded together and are seamlessly integrated into a single metallurgically-homogeneous object.

It should be noted that prior to mold material deposition (e.g., of Layer 1 in FIG. 3B), the ceramic paste of the mold material is kept at ambient temperature (for example, 16°-17° inside the dispenser (stage 10), however, as soon as the paste is extruded from the injection nozzle/syringe it experiences a thermal shock when it is deposited on the build table or the previously-fabricated production layers (stage 12) and encounters the surface (previously-dispensed mold material or previously-deposited metal) which is kept at an above-ambient temperature. For example, in order to shorten heating and cooling cycles of the production environment, the build table and the production environment including the already-deposited mold structure and object, may be kept each at predefined temperatures (for example, 200°-300° or 400°-600°). In defining the desired temperature of the mold structure, the mold material's solvent boiling temperature, polymerization rate, heat conductivity, and mass-transfer processes may need to be considered. The temperature changes experienced by the mold material bring about significant changes in the material properties (e.g., rheological, textural etc.) of the extruded ceramic-based material of the mold. For example, abrupt heating may cause release of solvents, swelling and crust formation on extruded ceramics' surface which further may negatively affect its adhesion with successive mold layers.

In some embodiments, the solvent used in the ceramic-based mold material is water which evaporates during stage 12 in FIG. 3B. Since the surface temperature is higher than 100° C., the deposited mold material undergoes a second thermal shock (stage 14) during which it undergoes further curing including binder polymerization, as was described above with reference to FIG. 2G. A certain level of drying of the mold material (step 262 in FIG. 2G) is required to allow surface treating, e.g., milling of the mold region. Milling (and/or other surface treatment types) is necessary to obtain a predetermined shape of the surface of the mold in contact with the metal, according to the shape of the metal object to be casted. Being viscous, the deposited mold material has a tube-shape. A sag is created upon mold material deposition. Without sag removal, the metal will undesirably conform with the shape of the sag. Surface treatment is further required to compensate for dispensing inaccuracies. As already mentioned above, no sintering of the mold region is required (stage 16 of FIG. 3A). After surface treatment of the metal-facing walls, the mold region of the current production layer is ready for metal deposition 18.

The mold region is exposed to a third thermal shock during metal deposition (stage 18) when the temperature transiently rises to metal melting temperatures (about 1200-1300° C. for gray iron and even higher for other metals). Following metal deposition of the first production layer, the mold region and the metal object cool down to the predefined temperatures (for example, about 400°-600°) and the additive manufacturing proceeds with the second production layer. The temperatures of the first, second and n-th production layers are indicated by solid, dashed and dot-dashed lines, respectively, in FIG. 3B. It can be seen in FIG. 3B that while the mold material of the second layer (dashed line) experiences its first cycle of thermal shocks, the mold region of the first production layer (solid line) continues to experience additional thermal shocks, up to the n-th production layer (dot-dashed line), after which the casting is ended, and all mold regions and metal object regions cool down. It is important to note that such transient mode of mold deposition in terms of thermodynamic conditions results in continuous extraction of solvents out of the mold material and continuous drying, which causes a continuous change of texture.

The mold material contains one or more binders, responsible for cohesion of the ceramic particles within the mold material, in general. During the additive casting according to the principles of the present disclosure, mold deposition is performed layer-by-layer, where the current layer of mold belonging to the current production layer, is deposited on top of a previous production layer (comprising mold region(s) and metal object region(s)) and is to form a cohesive mold structure together with the previous production layer. Therefore, the presence of the binder/s within the mold material of the mold region, increases adhesion between the just deposited mold material of the current production layer with the already deposited mold region of the previous production layer. the selection of mold temperature is also relevant: if the mold material of the current production layer were heated to the too high temperature right after deposition, its adhesion to the previous mold layers would be compromised as well as the integrity of the mold region during subsequent milling. The use of inorganic binders that polymerize at relatively high temperatures is advantageous. Nevertheless, horizontal cracks in the metal-facing zone of the mold region—that allows metal to breach between the mold layers may not be fully addressed by proper material and temperature selection. The use of metal-nonadjacent zone/s proximate to the metal-facing zone helps to withstand the compressive/tensile stresses developing inside the metal-facing walls due to expanding metal.

Another aspect of providing efficient drying of the mold region is connected to inhomogeneous drying of the mold material. Drying of the green ceramic body involves vapor diffusion within the porous ceramic body. This transport mechanism is sensitive to different parameters, among them the shape and the size of the wet body. If the solvent vapors from the surface of the mold exit the mold region easily, whereas the solvent vapors deeper inside the mold material thickness are trapped and cannot exit the mold fast enough, a crust would be formed on the mold surface during the drying stage. This crust further prevents an efficient exit of the solvent vapors from the mold and causes significant problems with the subsequent stage of mold milling (the mill may chip off mold pieces). Therefore, according to the technique of the present disclosure, the metal-nonadjacent zone is preferably configured with a crisscross pattern or curly pattern of the mold material which provides for an efficient exit of solvent vapors from the materials of the mold region during the drying stage.

The inventors found that using mold material composition having high compressibility, e.g., type MMT2 or MMT3 materials, in some of the mold region's zones or sub-zones may be advantageous to increase the overall mold stability. The relatively compressible mold material may be an elastic compressible material. The shape of an elastic compressible material (in the green state) is partially or fully restored after the applied stress is removed. In other words, elastic compressible material allows a substantially reversible deformation when released from compressive stress. However, to compressible material is a more general term and may describe also a material showing an irreversible deformation under compressive stress. Examples of materials having high compressibility include: compressible sand, ceramic-based material, compressible ceramic-based material, porous ceramics, ceramics by spraying, spheres, negative thermal expansion materials, reversibly compressible plastics, nanostructures, layered materials.

For ease of explanation, the different mechanical properties of different mold region zones are described with reference to different materials. It should be noted that different mechanical properties of the various mold region zones may be achieved for example by using a single base material applied in different manners to construct different mold zones. Porous ceramics is an example of a material that may be applied with different structures (pore size distribution, pore location distribution, etc.) giving rise to different mechanical properties. The pores may be filled by gases, e.g., air, and the material may be regarded as mostly brittle (as opposed to ductile). Under applied pressure, the pores within the ceramic material will be squeezed by the applied stress, and in the limit of the high stresses encountered during metal deposition, may eventually crack. However, porous ceramics may yet show a limited yield (more than most non-porous ceramics) allowing a limited but at times sufficient absorption of energy created by compressive stress.

The following are specific, not limiting examples of the mold region configurations, all configured according to the technique of the present disclosure, i.e., having a metal-facing zone and a metal-nonadjacent zone around the metal-facing zone, and, in some embodiments, also including an enclosure region. To facilitate understanding, the same reference numbers are used to identify components/elements common in all the examples.

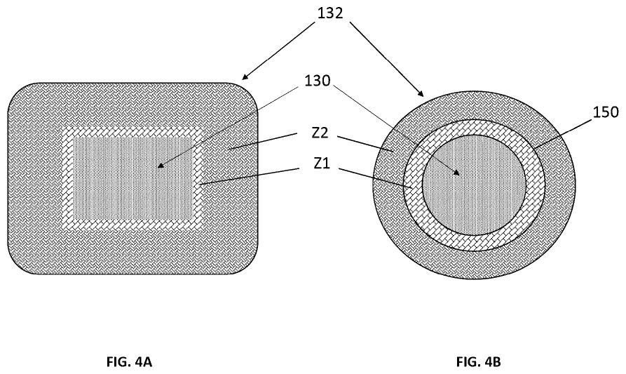

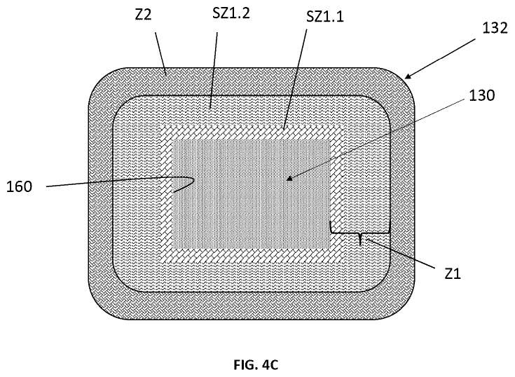

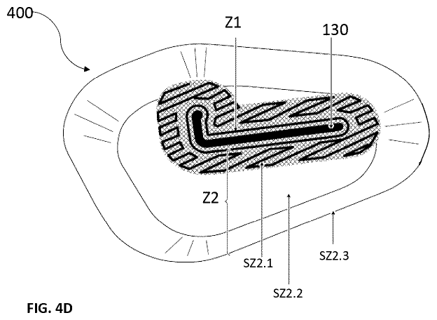

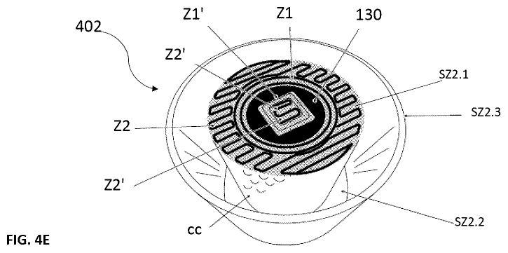

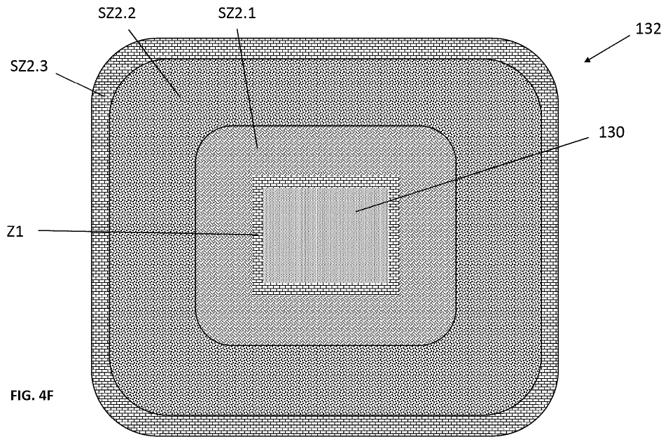

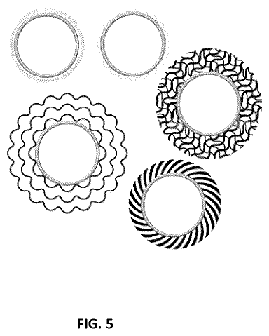

Reference is made to FIG. 4A showing an exemplary mold region 132 according to some embodiments of the present disclosure. The mold region 132 includes a metal-facing zone Z1 configured to define a cavity forming a metal object region 130, and a metal-nonadjacent zone Z2 around said metal-facing zone Z1. The metal-facing zone Z1 is made of a ceramic-based material, e.g., material of type MMT1. Generally, according to the present disclosure, the metal-facing zone and metal-nonadjacent zone of the mold region are distinct zones, and are different from one another in the material compositions and/or mold deposition process parameters.

Thus, in some embodiments, zones Z1 and Z2 of mold region 132 are made from different materials. For example, the metal-facing zone Z1 may be made of a ceramic-based material, e.g., dispensed as a ceramic paste tube, whereas the metal-nonadjacent zone Z2 may be made of sand to provide mechanical support to the metal-facing zone Z1. In another example, zones Z1 and Z2 of mold region 132 may be made of two ceramic-based materials with different properties, e.g., having different tensile/compressive strength and/or porosity, and/or viscosity.

In some embodiments, zones Z1 and Z2 of mold region 132 may be made from the same mold material (i.e., ceramic-based material) but applied in distinct deposition operations and under different deposition parameters. For example, the metal-facing zone Z1 may have a contour/tube shape defining the shape of the metal object and undergoing metal-facing surface treatment, while the metal-nonadjacent zone Z2 may be deposited as a second contour, enveloping the metal-facing contour (“double tube” or “double contour” configuration).

In some embodiments, the metal-facing zone Z1 may have a contour/tube shape defining the shape of the metal object, while the metal-nonadjacent zone Z2 may have a crisscross or a curly pattern, depending on the number of material deposition iterations required for the specific mold region 132 (“crisscross” configuration)

As already discussed above (with reference to FIG. 3B), the additive deposition of molten metal in the object region causes cyclic thermal shocks in the mold material of the previous and current production layers. Therefore, at least one mold provision device (112 in FIGS. 1 and 2) is configured and operable to reduce the material density, e.g., of the metal-nonadjacent zone Z2, e.g., by depositing the mold material to form the crisscross pattern, thereby enabling the mold region to withstand said cyclic thermal shocks. Reference is made to FIG. 4B showing an exemplary mold region 132 according to some embodiments of the present disclosure in which the mold region 132 includes metal-facing zone Z1 and metal-nonadjacent zone Z2 applied in distinct deposition operations creating two contours/tube shapes. In this embodiment, the same mold depositor (118 in FIGS. 1 and 2) may be used as well as the same mold material.

In some other embodiments, the metal-facing zone Z1 and metal-nonadjacent zone Z2 may be made of the same material but may undergo distinctly different surface treatment operations, e.g., only the metal-facing zone Z1 may undergo smoothing, etc. Further, mold region 132 may be configured such that the metal-facing zone Z1, by a non-metal facing side 150 thereof, is at least partially adhered to the metal-nonadjacent zone Z2.

Reference is made to FIG. 4C showing an exemplary mold region 132 according to some embodiments of the present disclosure. The mold region includes metal-facing and metal-nonadjacent zones Z1 and Z2. In this embodiment, the metal-facing zone Z1 includes a first sub-zone region SZ1.1 which by its metal-facing side 160 directly interfaces with the object region 130, and a second sub-zone SZ1.2 around the first sub-zone SZ1.1 at an opposite side of the first sub-zone SZ1.1. The first sub-zone SZ1.1 may be configured as an inner wall made of a refractory ceramic-based material operating as a metal-facing thermally isolating wall for said second-sub-zone SZ1.2. In some embodiments, the second sub-zone SZ1.2 of the metal-facing zone Z1 is made of a plastic material.

In some embodiments, the first metal-adjacent sub-zone is relatively narrow, at least by a factor of four, as compared to the outward relatively wide sub-zone, such that mechanical properties (e.g., compressibility, toughness) of the metal-facing zone formed by the relatively narrow metal-adjacent sub-zone and the relatively wide, outward sub-zone provide said different mechanical properties of the metal-facing zone as compared to the metal-nonadjacent zone. For example, the configuration may be such that the second outward sub-zone of the metal-facing zone is composed of a compressible ceramic-based material, and the first narrow sub-zone of the metal-facing zone is configured as a coating on a metal-facing side of the second outward sub-zone and is made of a refractory ceramic-based material suitable for said molten metal.

In the above described examples, the mold region 132 includes the metal-facing zone Z1 made of ceramic-based mold material and defines a shaping contour along the inner surface of the metal-facing zone Z1, which defines a respective metal object region 130. The porosity of the ceramic-based mold material of the metal-facing zone is configured to provide efficient solvent release during the described-above thermal shocks. It is important to note that the porosity of said mold material is preferably to be kept smaller than 60 μn, such that the molten metal would not invade the mold material during molten metal deposition. The inventors have shown that this limiting porosity can be sufficient to prevent metal breaching/leakage through the mold region thanks to the high enough surface tension of the molten metal (e.g., iron).

Reference is made to FIG. 4D showing an exemplary mold region 400 according to some embodiments of the present disclosure. The mold region 400 exemplified in the figure is actually partially fabricated (intermediate stage of the mold region fabrication). More specifically, the mold region 400 includes metal-facing zone Z1 and metal-nonadjacent zone Z2. Metal-facing zone Z1 has a shape of a paste tube—its crest is shown in a solid line. Metal-nonadjacent zone Z2 is composed of a support sub-zone SZ2.1, dispensed in a curly pattern as discussed above (the crest of the tube shaped curly pattern is shown in a solid line). Metal facing zone Z1 and support sub-zone SZ2.1 of the metal-non-adjacent zone Z2 are surrounded by an enclosure sub-zone SZ2.3 of the metal-non-adjacent zone Z2, which is illustrated as being spaced from the support sub-zone SZ2.1 by a space SZ2.2 which is to be filled by a filler (e.g., a tensile filler, or compressible filler—any one of mold material types: MMT2, MMT3 or any other).

Mold region 400 of FIG. 4D is shown at interim construction phase: after ceramic paste deposition and fabrication of metal facing zone Z1, and support SZ2.1 and enclosure SZ2.3 sub-zones of the metal-non-adjacent zone Z2; before filling space SZ2.2 with a filler material; before providing surface treatment to metal facing zone Z1; and before depositing molten metal into object region 130.

The support sub-zone SZ2.1 may be made of the same or different mold material as compared to the metal-facing zone Z1. The support material is selected to provide mechanical support to the metal-facing zone Z1. The spaced crisscross pattern (or curly pattern) provides enlarged surface area, thereby allowing fast heat and vapor transport from the mold materials of both the metal-facing zone Z1 and metal-nonadjacent support sub-zone SZ2.1 during the cyclic thermal shocks of said mold zones. The vapor may originate from the evaporation of mold solvents (e.g., water) and organic/inorganic residuals of binders continuously released as a result of cyclic mold drying and metal placement during multiple production layers. As already noted above, efficient vapor transport is important to prevent swelling of the mold region and crust formation on the surface of the mold region.

Reference is made to FIG. 4E showing another exemplary mold region 402 according to some embodiments of the present disclosure. Like in the example of FIG. 4D, the example of FIG. 4E illustrates an intermediate stage of the mold region fabrication. The mold region 402 includes metal-facing zones Z1, Z1′ and metal-nonadjacent zones comprising support sub-zones SZ2.1, SZ2.1′, an enclosure sub-zone SZ2.3, spaced from another sub-zone by a space SZ2.2 which is to be filled by ceramic mold material (not shown) or another filler (e.g., sand) (not shown) to complete the mold region 132.

In the example of FIG. 4E, the mold region 402 is configured to define a ring-like cavity for a ring-like object region 130. Accordingly, the mold region 402 includes two metal facing zones Z1 and Z1′, defining opposite surfaces of the ring-like cavity 130, and two corresponding metal-nonadjacent zones: zone Z2′ in the form of mold insert at the center of the ring, and zone Z2 around the metal-facing zone Z1.

The metal-nonadjacent zones Z2, Z2′ have crisscross patterns (or curly patterns) providing support to the metal-facing zones Z1, Z1′.

Metal non-adjacent zones Z2, Z2′ are constructed by depositing a tube-shaped paste in a curly pattern applied with a predetermined direction. The crest line of the paste tube is shown in FIG. 4E in solid lines. In some embodiments, the crisscross pattern is realized by depositing the mold paste in a curly pattern such that the direction of the curly pattern in one deposition iteration crosses the direction of the curly pattern in the successive mold deposition iteration. This is illustrated in FIG. 4E by markings CC representing a few curls of the crisscross pattern created in previously-deposited mold regions. The alternating positions of the curls are shown. This allows for air gaps between mold tube sections of the same deposition iterations as well as between mold tube sections of successive deposition iterations. The crisscross pattern may be created within a production layer or in a stack of production layers, and the airgaps may be distributed along the support structure, improving the evaporation of mold material components and drying.

As already noted above, the spaced crisscross pattern (typically produced in multiple iterations of material deposition) or curly pattern (discontinuity of the mold material) provides for a significantly shorter deposition time of the mold region as compared to a metal-nonadjacent zone completely filled with the mold material (continuity of the mold material). This time saving is significant during additive manufacturing according to the present disclosure in which each production layer out of multiple production layers provides a mold region defining one or more respective object regions and is configured to receive molten metal deposited to each of the one or more object regions.

FIG. 4F exemplifies the full mold region 132 of the general configuration of FIG. 4D. More specifically, mold region 132 includes metal-facing zone Z1, metal-nonadjacent zone Z2 around the metal facing zone Z1, and an enclosure zone around the metal-non-adjacent zone Z2. The structure formed by the metal non-adjacent zone and the enclosure zone may be described as multiple sub-zones of the metal non-adjacent zone Z2 including a first sub-zone SZ2.1 interfacing the metal-facing zone Z1, second sub-zone SZ2.2 surrounding the sub-zone SZ2.1 and made of a relatively highly compressible mold material, and an outer sub-zone SZ2.3 around the sub-zone SZ2.2.

It should be noted, although not specifically shown that the first sub-zone SZ2.1 of the metal-non-adjacent zone is preferably made with crisscross pattern (or curly pattern) providing support to the metal-facing zone Z1.

FIG. 5 illustrates, in a self-explanatory manner, specific not-limiting examples of various configurations of zones/sub-zones around the metal-facing zone.

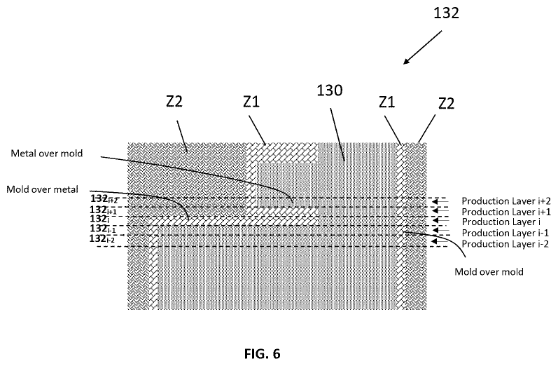

FIG. 6 shows a cross section of a mold structure comprising several mold regions 132 and object regions 130 in multiple production layers—five production layers, (i−2), (i−1), i, (i+1), and (i+2) being shown in the figure. The mold regions of all the production layers comprise a metal-facing zone Z1 and a metal non-adjacent zone Z2. In this example, the metal object has a certain surface relief along its outer surface resulting in different alignments between the mold regions of different production layers.

As exemplified with respect to productions layers (i−2) and (i−1), the respective mold regions 132ᵢ₋₁ and 134ᵢ₋₂ are completely vertically aligned, such that both the metal-facing zones Z1ᵢ₋₁ and the metal non-adjacent zone Z2ᵢ₋₁ of the mold region 132ᵢ₋₁ are deposited on top of the respective Z1ᵢ₋₁ and Z2ᵢ₋₂ zones of the mold region 1342 of the preceding production layer (i−2). In the production layer i, due to a change in the surface profile of the object region and accordingly of the shape of the metal-facing zone Z1; of mold region 132ᵢ, the mold material of the metal-facing zone Z1ᵢ is deposited over/aligned with the deposited metal (part of object region) of the preceding production layer (i−1), as was dictated by the narrower profile of the metal object in the building plan. Notably, the metal deposition of production layer (i+2) was performed, partially, over the mold material deposited during the construction of mold region of layer (i+1). Thus, in production layer i, a part segment of the mold region 132i is a so-called “mold over metal” part, and a part of the object region 130ᵢ₊₂ in production layer (i+2) is a so-called “metal over mold” part.

As described above, the configuration of the mold regions, as well as relative accommodation of the mold regions of adjacent production layers are defined by the configuration of the object to be manufactured concurrently with the mold structure. For simplicity of illustration, the configuration of the mold region as a two-zone configuration, was illustrated with simplified designs such as a circular or ring cross sections. In such illustrations—for example, as illustrated in FIGS. 4A-4F, the metal-facing zone faces metal residing in the same production layer. However, as is evident from FIG. 6, in some production scenarios, the metal-facing zone of production layer i may face metal residing in the next production layer—production layer i+1 (the ‘metal over mold’ production scenario). Consequently, surface treatment, if applied to the metal facing zone, may be performed on the inner walls of the cavity formed by the mold region in production layer i. The surface treatment may further be applied to the upper surface of the mold region, to thereby define a cavity forming the metal object region that would be deposited in the successive production layer i+1.

In other production scenarios, the metal-facing zone of production layer i may face metal residing in the previous production layer—production layer i−1 (the ‘mold over metal production scenario). The temperature of the metal region in production layer i−1 may be higher than the temperature of sections of the mold region in production layer i−1. Consequently, different sections of mold region in production layer I may experience different temperatures upon deposition.

The use of two-zones (or more) mold region, distinct from each other in at least one of material composition and mold deposition process parameters, was described mainly with reference to the distinct mechanical properties of the distinct mold region zones. The implementation of the distinct mechanical properties of the two-zones (or more) was exemplified with respect to improving the stress absorption of the mold structure.

The invention is not limited to the exemplified implementation and others are possible within the scope of the present disclosure.

The metal-nonadjacent zone (e.g., support sub-zone SZ2.1 shown in FIG. 4D), may be deposited in various manners and shapes, each yielding different mechanical behaviors. Crack deflection, for example, may be achieved by spiral printing—changing the direction of deposition as a function of the tube radius. Wave-shaped metal-nonadjacent zone on the perimeter of the metal facing zone may provide improved longitudinal resistance to tension.

Additional material parameters may be distinctly used in the metal facing zones and metal-nonadjacent zones. For example, distinct concentrations of inoculants in the distinct mold zones may provide controllable metal properties and improved deposition throughput.

As used throughout the specification, the terms “metal” or “metallic” refers to any metals and/or mellitic alloys which are suitable for melting and casting, for example, ferrous alloys, aluminum alloys, copper alloys, nickel alloys, magnesium alloys, and the like.

Any reference in the specification to a method should be applied mutatis mutandis to a system capable of executing the method and should be applied mutatis mutandis to a non-transitory computer-readable medium that stores instructions that, once executed by a computer, result in the execution of the method. Any reference in the specification to a system should be applied mutatis mutandis to a method that may be executed by the system and should be applied mutatis mutandis to a non-transitory computer-readable medium that stores instructions that may be executed by the system.

The terms “front,” “back,” “top,” “bottom,” “over,” “under”, and the like in the description and in the claims, if any, are used for descriptive purposes and not necessarily for describing permanent relative positions. It is understood that the terms so used are interchangeable under appropriate circumstances such that the embodiments of the present disclosure described herein are, for example, capable of operation in other orientations than those illustrated or otherwise described herein.

The subject matter regarded as the technique of the present disclosure is particularly pointed out and distinctly claimed in the concluding portion of the specification. The technique of the present disclosure, however, both as to organization and method of operation, together with objects, features, and advantages thereof, may best be understood by reference to the detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

In the claims, any reference signs placed between parentheses shall not be construed as limiting the claim. The word ‘comprising’ does not exclude the presence of other elements or operations and stages than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the technique of the present disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the present disclosure.

1. A mold construction system for use in additive manufacturing of a metal object, the mold construction system comprising: at least one mold provision device controllably operable to form one or more mold regions defining one or more respective metal object regions in a production layer; and a control system configured to operate said at least one mold provision device in accordance with a predetermined building plan;
wherein said at least one mold provision device is controllably operable, in accordance with said predetermined building plan, to create each of said one or more mold regions by sequentially forming the following: a metal-facing zone configured to define a cavity forming the metal object region, and a metal-nonadjacent zone around said metal-facing zone,
wherein the metal-facing zone of the mold region is made of a ceramic-based material and is distinct from the metal-nonadjacent zone of said mold region in at least one of material composition and mold deposition process parameters.

2. The system according to claim 1, wherein said metal non-adjacent zone of the mold region is configured to provide a mechanical support to the metal-facing zone of said mold region.

3. The system according to claim 2, wherein said metal non-adjacent zone of the mold region comprises a ceramic-based material.

4. The system according to claim 1, wherein said at least one mold provision device is controllably operable to create the metal non-adjacent zone of the mold region comprising a crisscross pattern.

5. The system according to claim 4, wherein said at least one mold provision device is controllably operable to create the metal non-adjacent zone of the mold region in multiple iterations of material deposition to form said crisscross pattern.

6. The system according to claim 1, wherein said at least one mold provision device is controllably operable to create the metal non-adjacent zone of the mold region comprising a curly pattern.

7. The system according to claim 4, wherein said at least one mold provision device is controllably operable to create the metal non-adjacent zone of the mold region with enlarged surface area and reduced material density, allowing fast heat and vapor transport from said metal-facing and metal-nonadjacent zones of the mold region.

8. The system according to claim 4, wherein said at least one mold provision device is controllably operable to create the metal non-adjacent zone of the mold region configured to enable fast formation of said metal-nonadjacent zone of the mold region.

9. The system according to claim 1, wherein said at least one mold provision device is configured and operable with varying one or more of mold material deposition parameters and conditions to form the mold region, prior to deposition of the molten metal to form the respective object region of the current production layer, wherein said varying one or more mold material deposition parameters are selected to create said metal-facing zones and said metal-nonadjacent zone of the mold region with the reduced material density capable of undergoing cyclic thermal shocks associated with said additive deposition of the molten metal of the object region.

10. The system according to claim 9, wherein the reduced material density of each the metal-facing zone and the metal-nonadjacent zone is defined by porosity of the mold material thereof.

11. The system according to claim 10, wherein said reduced material density is defined by the porosity with pore sizes substantially not exceeding 60 μm.

12. The system according to claim 3, wherein the ceramic-based material is in green state.

13. The system according to claim 3, wherein the ceramic-based material is characterized by viscosity of at least 40K cps.

14. The system according to claim 1, wherein said at least one mold provision device is configured and operable to provide the mold region characterized by at least one of the following:
the metal-facing zone and the metal-nonadjacent zone of the mold region comprise, respectively, first and second different mold material compositions;
the metal-facing zone, by a non-metal facing side thereof, is at least partially adhered to the metal-nonadjacent zone;
the metal-facing zone includes a first sub-zone which by its metal-facing side directly interfaces with the object region and a second sub-zone around said first sub-zone at an opposite side of the first sub-zone, said first sub-zone being configured as an inner wall made of a refractory compressible ceramic-based material operating as a metal-facing thermally isolating wall for said second-sub-zone; and
the mold region comprises an enclosure around said metal-nonadjacent zone, said enclosure being spaced from the metal-nonadjacent zone by a gap filled with a mold material composition having higher compressibility than said metal-nonadjacent zone.

15. The system according to claim 1, wherein the metal-facing zone includes a first sub-zone which by its metal-facing side directly interfaces with the object region and a second sub-zone around said first sub-zone at an opposite side of the first sub-zone, said first sub-zone being configured as an inner wall made of a refractory compressible ceramic-based material operating as a metal-facing thermally isolating wall for said second-sub-zone, the second sub-zone of the metal-facing zone being made of a plastic material.

16. The system according to claim 1, wherein said mold region further comprises an enclosure around said metal-nonadjacent zone, said enclosure being spaced from the metal-nonadjacent zone by a gap filled with a mold material composition having higher compressibility than said metal-nonadjacent zone, said mold material composition having higher compressibility comprising one or more of the following: compressible sand, ceramic-based material, compressible ceramic-based material, porous ceramics, ceramics by spraying, spheres, negative thermal expansion materials, reversibly compressible plastics, nanostructures, layered materials.

17. The system according to claim 1, wherein said at least one mold provision device is controllably operable in accordance with said building plan which is further indicative of two or more of the following: geometric layout of the one or more object regions in each of the production layers; material, geometrical properties and arrangement of the metal-facing and metal-nonadjacent zones of each mold region in each of the production layers; surface treatment parameters and conditions of surface treatment of the mold region; and synchronization data for the mold regions and object regions formation in the production layers.

18. The system according to claim 1, further comprising a surface treatment system configured and operable to apply one or more surface treatments to the mold region.

19. The system according to claim 18, wherein the surface treatment system is configured and operable to carry out at least one of the following:
apply temperature treatment to the mold region;
apply temperature treatment to the mold region to provide material hardening in the mold region;
perform mechanical surface treatment of at least a part of the mold region.

20. The system according to claim 18, wherein the surface treatment system is configured and operable to perform mechanical surface treatment of at least a part of the mold region including a surface of the metal-facing zone by which it interfaces said object region.

21. The system according to claim 1, wherein said at least one mold deposition device comprises one or more traveling mold depositors, each traveling in a horizontal plane according to a predetermined trajectory and being associated with one or more mold material reservoirs.

22. The system according to 21, wherein said at least one mold deposition device is characterized by at least one of the following: the mold deposition device comprises one or more extruders each in fluid communication with said one or more traveling depositors; and each of said one or more traveling depositors comprises at least one of the following: stirrers, tubing, and tubing loop configured to perform continuous circulation of the mold material not currently involved in deposition process.

23. The system according to claim 1, comprising a build table configured to be placed in a temperature-controlled environment.

24. The system according to claim 21, comprising a build table configured to be placed in a temperature-controlled environment, the system being configured to provide relative displacement between said one or more traveling depositors and the build table.

25. The system according to claim 1, configured and operable to create the mold region of a current production layer on top of either at least a part of a preceding mold region of a preceding production layer or on at least a part of a preceding object region of the preceding production layer, depending on a surface relief of the metal object region being manufactured.

26. A production part comprising: a stack of production layers, each manufactured by the method of claim 31, the production layers comprising: one or more object regions of a metal object, each object region being surrounded by a mold region, wherein the mold region comprises a metal-facing zone, and a metal-nonadjacent zone around the metal-facing zone, such that a surface of the metal object in said object region and a metal-facing surface of the metal-facing zone of the mold region are physically coupled between them, said metal-facing zone being distinct from the metal-nonadjacent zone of said mold region in at least one of material composition and mold deposition process parameters.

27. The production part according to claim 26, wherein said metal non-adjacent zone is characterized by at least one of the following: the metal non-adjacent zone is configured to provide a mechanical support to said metal-facing zone; the metal non-adjacent zone comprises a ceramic-based material; and the metal non-adjacent zone is formed with a crisscross pattern.

28. An additive casting system for additively casting of a metallic object by producing multiple production layers having mold regions and object regions within cavities defined by the mold regions, one current production layer after the other on a movable build table up to a top production layer, the system comprising:
the mold construction system of claim 1, and
an object construction device configured and operable to construct each current production layer by depositing molten metal in each of one or more object regions defined by each of the respective one or more mold regions in said current production layer.

29. The additive casting system according to claim 28, wherein said object construction device comprises one or more molten metal depositors; and a control system configured to operate said one or more molten metal depositors in accordance with a predetermined building plan which is indicative of the following: geometric layout of the one or more object regions in each of the production layers; and synchronization data for the mold regions and object regions formation in the production layers.

30. The system according to claim 28, wherein said object construction device is configured and operable to create the object region of a current production layer on top of either at least a part of a preceding mold region of a preceding production layer or on at least a part of a preceding object region of the preceding production layer, depending on a surface relief of the metal object region being manufactured.

31. A method for use in additive manufacturing of a metal object, the method comprising:
providing the additive casting system of claim 28;
operating said additive casting system for constructing successive production layers, each including a number of mold regions defining a respective number of metal object regions, wherein the constructing of each production layer is controllably performed in accordance with a predetermined building plan, by carrying out the following: for each production layer, prior to deposition of molten metal material in the number of object regions, creating said number of mold regions, where each of the mold regions is created by depositing one or more mold materials to sequentially form the following: a metal-facing zone configured to define a cavity forming the metal object region, and a metal-nonadjacent zone around said metal-facing zone, wherein the metal-facing zone of the mold region is made of a ceramic-based material and is distinct from the metal-nonadjacent zone of said mold region in at least one of material composition and mold deposition process parameter.
